(19) United States
(12) Patent Application Publication
(10) Pub. No.: US 2004/0092700 A1
(43) Pub. Date: May 13, 2004

(54) Methods for directly producing stable aqueous dispersions of electrically conducting polyanilines

(76) Inventor: Che-Hsiung Hsu, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/641,992

(22) Filed: Aug. 14, 2003

Related U.S. Application Data
(60) Provisional application No. 60/405,556, filed on Aug. 23, 2002.

(51) Int. Cl. C08G 73/00

(52) U.S. Cl. 528/210; 528/422

(57) ABSTRACT

Methods are provided for directly producing a stable aqueous dispersion of an electrically conducting polyaniline, comprising synthesizing an electrically conducting polyaniline in the presence of a polymeric acid in aqueous solution, thereby forming an as-synthesized aqueous dispersion comprising the electrically conducting polyaniline and the polymeric acid, and contacting the as-synthesized aqueous dispersion with at least one ion exchange resin under conditions suitable to produce a stable aqueous dispersion of an electrically conducting polyaniline. Aqueous dispersions produced by the methods of the invention are useful for preparing buffer layers for use in electroluminescent (EL) devices.

### FIELD OF THE INVENTION

The invention relates to the use of aqueous dispersions of electrically conducting polyanilines in the production of electroluminescent devices, such as, for example, polymer light emitting diodes.

### BACKGROUND OF THE INVENTION

Electrically conducting polymers have been used in the development of electroluminescent (EL) devices for use in light emissive displays. EL devices such as organic light emitting diodes (OLEDs) containing conducting polymers generally have the following configuration:

anode/buffer layer/EL polymer/cathode

The anode is typically any material that has the ability to inject holes into the otherwise filled π-band of the semiconducting, EL polymer, such as, for example, indium/tin oxide (ITO). The anode is optionally supported on a glass or plastic substrate. The EL polymer is typically a conjugated semiconducting polymer such as poly(paraphenylenevinylene) or polyfluorene. The cathode is typically any material (such as, e.g., Ca or Ba) that has the ability to inject electrons into the otherwise empty π*-band of the semiconducting, EL polymer.

The buffer layer is typically a conducting polymer and facilitates the injection of holes from the anode into the EL polymer layer. The buffer layer can also be called a hole-injection layer, a hole transport layer, or may be characterized as part of a bilayer anode. Typical conducting polymers employed as buffer layers include polyaniline (Pani) and polydioxythiophenes such as poly(3,4-ethylenedioxythiophene) (PEDT). These materials are typically prepared by polymerizing aniline or dioxythiophene monomers in aqueous solution in the presence of a polymeric acid, such as poly(styrenesulfonic acid) (PSSA). A well known PEDT/PSSA material is Baytron®-P, commercially available from H. C. Starck (Leverkusen, Germany).

Buffer layers used in EL devices are typically cast from aqueous dispersions of electrically conducting polymers and a polymeric acid. Aqueous PAni dispersions are well known and are usually prepared by first isolating the conductive PAni/polymeric acid material (e.g., PAni/PSSA) from the aqueous polymerization medium. The isolation is typically carried out by adding a copious amount of a non-solvent (or precipitation solvent, e.g., acetone) for the conducting polymer to the aqueous polymerization medium, thereby precipitating the conductive polymer. The precipitated conducting polymer is then washed with additional precipitation solvent and dried. Finally, the dried conducting polymer is redispersed in water, thereby forming the aqueous dispersion used to cast buffer layers.

However, the isolation and redispersion of the conducting PAni is costly due to the large amount of precipitation solvent used and the length of time involved therein. In addition, this process often renders the isolated polymer difficult to redisperse in water, and the viscosity of such dispersions tends to vary as the dispersions are stored for long periods of time.

Accordingly, there is a need for producing stable, aqueous dispersions of electrically conducting polyanilines directly from the polymerization medium, i.e., without the need for isolation and redisperion of the electrically conducting polymeric material. The invention addresses this need and also provides further advantages.

### SUMMARY OF THE INVENTION

Methods are provided for directly producing stable aqueous dispersions of electrically conducting polyanilines, comprising

a) synthesizing an electrically conducting polyaniline in the presence of a polymeric acid in aqueous solution, thereby forming an as-synthesized aqueous dispersion comprising the electrically conducting polyaniline and the polymeric acid, and

b) contacting the as-synthesized aqueous dispersion with at least one ion exchange resin under conditions suitable to produce a stable aqueous dispersion of an electrically conducting polyaniline.

In another embodiment of the invention, there are provided methods for reducing conductivity of a polyaniline/polymeric acid buffer layer cast from aqueous solution onto a substrate to a value less than about 1×10⁻⁴ S/cm, comprising contacting the aqueous solution with at least one ion exchange resin under conditions suitable to reduce conductivity of a polyaniline/polymeric acid buffer layer cast or deposited by any number of deposition techniques including, but not limited to continuous and discontinuous techniques such as, Gravure coating, stamping, screen printing, extruding, slit-die coating, printing, ink-jetting, ink-dispensing, dipping, spin-coating, rolling, and curtain coating and other conventional techniques.

In another embodiment of the invention, the polyaniline/polymeric acid dispersion has a pH greater than 1.5. In another embodiment, the polyaniline/polymeric acid dispersion has a pH greater than 3.0

In yet another embodiment of the invention, there are provided methods for stabilizing the room temperature viscosity of an as-synthesized aqueous dispersion of an electrically conducting polyaniline, comprising contacting the dispersion with at least one ion exchange resin, wherein the contacting is carried out under conditions suitable to stabilize the room temperature viscosity of the aqueous dispersion.

In a still further embodiment of the invention, there are provided stable aqueous dispersions of an electrically conducting polyanline, wherein the viscosity of the dispersion fourteen days (336 hours) after it is formed is at least 80% of the initial viscosity.

In a still further embodiment of the invention, there are provided stable aqueous dispersions of an electrically conducting polyanline produced according to the invention methods.

In a still further embodiment of the invention, there are provided buffer layers produced according to the invention methods.

In still another embodiment of the invention, there are provided electroluminescent (EL) devices comprising buffer layers produced according to invention methods.

### BRIEF DESCRIPTION OF THE FIGURES

FIG. 1 illustrates a cross-sectional view of an electronic device that includes a buffer layer according to the invention.

### DETAILED DESCRIPTION OF THE INVENTION

Methods are provided for directly producing a stable aqueous dispersion of an electrically conducting polyaniline comprising synthesizing an electrically conducting polyaniline in the presence of a polymeric acid in aqueous solution, thereby forming an as-synthesized aqueous dispersion comprising the electrically conducting polymer and the polymeric acid, and contacting the as-synthesized aqueous dispersion with at least one ion exchange resin under conditions suitable to produce a stable aqueous dispersion of an electrically conducting polyaniline.

As used herein, the term “directly” means that stable aqueous dispersions are produced without the need for isolation (e.g., by precipitation) of the electrically conducting polymer from the aqueous polymerization solution.

As used herein, the term “dispersion” refers to a continuous medium containing a suspension of minute particles. In accordance with the invention, the “continuous medium” is typically an aqueous liquid, e.g., water, and the minute particles comprise the electrically conducting polyaniline and the polymeric acid.

As used herein, the term “stable”, when used with reference to an aqueous dispersion, means the viscosity of the aqueous dispersion remains substantially constant when stored over a period of time at room temperature, for example, at least about one month.

As used herein, the term “as-synthesized”, when used with reference to an aqueous dispersion, refers to an aqueous dispersion of an electrically conducting polyaniline prior to contact with an ion exchange resin. An example of such an as-synthesized aqueous dispersion is an aqueous polymerization solution, e.g., the solution in which the polymerization has taken place (e.g., to completion), but has not been contacted with an ion exchange resin.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Ion exchange is a reversible chemical reaction wherein an ion in a fluid medium (such as an aqueous dispersion) is exchanged for a similarly charged ion attached to an immobile solid particle that is insoluble in the fluid medium. The term “ion exchange resin” is used herein to refer to all such substances. The resin is rendered insoluble due to the crosslinked nature of the polymeric support to which the ion exchanging groups are attached. Ion exchange resins are classified as acidic, cation exchangers, which have positively charged mobile ions available for exchange, and basic, anion exchangers, whose exchangeable ions are negatively charged.

Both acidic, cation exchange resins and basic, anion exchange resins are contemplated for use in the practice of the invention. In one embodiment, the acidic, cation exchange resin is an inorganic acid, cation exchange resin, such as a sulfonic acid cation exchange resin. Sulfonic acid cation exchange resins contemplated for use in the practice of the invention include, for example, sulfonated styrene-divinylbenzene copolymers, sulfonated crosslinked styrene polymers, phenolformaldehyde-sulfonic acid resins, benzene-formaldehyde-sulfonic acid resins, and the like. In another embodiment, the acidic, cation exchange resin is an organic acid, cation exchange resin, such as carboxylic acid cation exchange resin.

In another embodiment, the basic, anionic exchange resin is a tertiary amine anion exchange resin. Tertiary amine anion exchange resins contemplated for use in the practice of the invention include, for example, tertiary-aminated styrene-divinylbenzene copolymers, tertiary-aminated crosslinked styrene polymers, tertiary-aminated phenol-formaldehyde resins, tertiary-aminated benzene-formaldehyde resins, and the like. In a further embodiment, the basic, anionic exchange resin is a quaternary amine anion exchange resin.

In accordance with the invention, stable aqueous dispersions are prepared by first synthesizing an electrically conducting polyaniline in the presence of a polymeric acid in aqueous solution, thereby forming an as-synthesized aqueous dispersion comprising the electrically conducting polyaniline and the polymeric acid. The electrically conducting polyanilines employed in invention methods are typically prepared by oxidatively polymerizing aniline or substituted aniline monomers in aqueous solution in the presence of an oxidizing agent, such as ammonium persulfate (APS), sodium persulfate, potassium persulfate, and the like. The aqueous solution contains at least enough of a suitable polymeric acid (e.g., poly(2-acrylamido-2-methyl-1-propanesulfonic acid (PAAMPSA), PSSA, and the like) to form acid/base salts with the emeraldine base of polyaniline, wherein formation of the acid/base salt renders the polyanilines electrically conductive. Thus, for example, the emeraldine base of polyaniline is typically formed with PAAMPSA to afford PAni/PMMPSA. The aqueous solution also may include a polymerization catalyst, such as ferric sulfate, ferric chloride, and the like, which typically have a higher oxidation potential than, for example, APS. The polymerization is typically carried out at low temperatures, e.g., between −10° C. and 30° C.

After completion of the polymerization reaction, the as-synthesized aqueous dispersion is contacted with at least one ion exchange resin under conditions suitable to produce a stable, aqueous dispersion. In one embodiment, the as-synthesized aqueous dispersion is contacted with a first ion exchange resin and a second ion exchange resin. In another embodiment, the first ion exchange resin is an acidic, cation exchange resin, such as a sulfonic acid cation exchange resin as set forth above, and the second ion exchange resin is a basic, anion exchange resin, such as a tertiary amine or quaternary exchange resin as set forth above.

The first and second ion exchange resins may contact the as-synthesized aqueous dispersion either simultaneously, or consecutively. For example, in one embodiment both resins are added simultaneously to an as-synthesized aqueous dispersion of an electrically conducting polymer, and allowed to remain in contact with the dispersion for at least about 1 hour, e.g., about 2 hours to about 20 hours. The ion exchange resins can then be removed from the dispersion by filtration. The size of the filter is chosen so that the relatively large ion exchange resin particles will be removed while the smaller dispersion particles will pass through. Without wishing to be bound by theory, it is believed that the ion exchange resins effectively remove ionic and non-ionic impurities from the as-synthesized aqueous dispersion. Moreover, the basic, anion exchange resin removes some of the polymeric acid from the as-synthesized dispersion or renders the acidic sites more basic, resulting in increased pH of the dispersion and reduced conductivity of buffer layers cast therefrom. In general, at least about 1 gram of ion exchange resin is used per 1 gram polyaniline/polymeric acid. Typical 1 to 3 grams of ion exchange resin is used per 1 gram polyanline/polymeric acid.

The aqueous dispersions of the invention have viscosities that do not change significantly with time. In one embodiment, the viscosity of the aqueous dispersion after 336 hours, when measured at a shear rate of 10 s⁻¹, is at least 80% of the initial viscosity. In another embodiment, the viscosity of the aqueous dispersion after 336 hours, when measured at a shear rate of 10 s⁻¹, is at least 90% of the initial viscosity. In another embodiment, the viscosity of the aqueous dispersion after 504 hours, when measured at a shear rate of 10 s⁻¹, is at least 75% of the initial viscosity.

Electrically conducting polymers contemplated for use in the practice of the invention are polyanilines, synthesized from aniline monomers or substituted aniline monomers such as toluidine or anisidine.

Polymeric acids contemplated for use in the practice of the invention are typically polymeric sulfonic acids, polymeric carboxylic acids, polymeric phosphoric acids, and the like. In one embodiment, the polymeric acid is a polymeric sulfonic acid, such as poly(2-acrylamido-2-methyl-1-propanesulfonic acid) (PAAMPSA), polystyrenesulfonic acid, poly(2-methylstyrene sulfonic acid), poly(4-phenylstyrene sulfonic acid), sulfonated poly(α-vinyl naphthalene), poly (vinyl sulfonic acid), sulfonated poly(vinyl benzoate), sulfonated poly(benzyl acrylate), sulfonated poly(benzyl methacrylate), and the like. In another embodiment, the polymeric sulfonic acid is poly(2-acrylamido-2-methyl-1-propanesulfonic acid) (PAAMPSA).

In still another embodiment of the invention, there are provided methods for reducing conductivity of a PANI/PMMPSA buffer layer cast from aqueous solution onto a substrate. In the invention method an aqueous solution is contacted with an acidic, cation exchange resin and a basic, anion exchange resin under conditions suitable to reduce conductivity of a PANI/PAAMPSA buffer layer cast therefrom, for example to a value less than about 1×10⁻⁴ S/cm (Siemens per centimeter) In pixellated electroluminescent devices, buffer layers having high resistance (i.e., low conductivity) are desired to eliminate or minimize crosstalk between neighboring pixels. Inter-pixel current leakage significantly reduces power efficiency and limits both the resolution and clarity of the electroluminescent device.

In a further embodiment, there are provided aqueous polyaniline/polymeric acid dispersions with pH greater than 1.5. In the invention method, an aqueous solution is contacted with an acidic, cation exchange resin and a basic, anion exchange resin under conditions suitable to increase the pH of the resulting dispersion to greater than 1.5. In one embodiment the pH is greater than 3. Using a less acidic or high pH material leads to significantly less etching of the indium/tin oxide layer during device fabrication and hence much lower concentration of indium and tin ions diffusing into the polymer layers of the OLED. Since In and Sn ions are suspected to contribute to reduced operating lifetime this is a significant benefit.

PANI/PMMPSA layers prepared according to the invention may be cast onto substrates using a variety of techniques well-known to those skilled in the art. Casting is typically carried out at room temperature, although casting may also be carried out at higher or lower temperatures as known in the art. The buffer layers are typically cast from a variety of aqueous solutions, such as, water, mixtures of water with water soluble alcohols, mixtures of water with tetrahydrofuran (THF), mixtures of water with dimethyl sulfoxide (DMSO), mixtures of water with dimethylformamide (DMF), or mixtures of water with other water-miscible solvents.

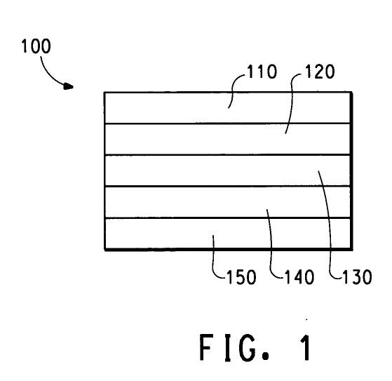

In a still further embodiment, there are provided electroluminescent (EL) devices comprising buffer layers produced according to invention methods. As shown in FIG. 1, a typical device has an anode layer 110, a buffer layer 120, an electroluminescent layer 130, and a cathode layer 150. Adjacent to the cathode layer 150 is an optional electron-injection/transport layer 140. Between the buffer layer 120 and the cathode layer 150 (or optional electron injection/transport layer 140) is the electroluminescent layer 130.

The device may include a support or substrate (not shown) that can be adjacent to the anode layer 110 or the cathode layer 150. Most frequently, the support is adjacent the anode layer 110. The support can be flexible or rigid, organic or inorganic. Generally, glass or flexible organic films are used as a support. The anode layer 110 is an electrode that is more efficient for injecting holes compared to the cathode layer 150. The anode can include materials containing a metal, mixed metal, alloy, metal oxide or mixed oxide. Suitable materials include the mixed oxides of the Group 2 elements (i.e., Be, Mg, Ca, Sr, Ba, Ra), the Group 11 elements, the elements in Groups 4, 5, and 6, and the Group 8-10 transition elements. If the anode layer 110 is to be light transmitting, mixed oxides of Groups 12, 13 and 14 elements, such as indium-tin-oxide, may be used. As used herein, the phrase “mixed oxide” refers to oxides having two or more different cations selected from the Group 2 elements or the Groups 12, 13, or 14 elements. Some non-limiting, specific examples of materials for anode layer 110 include indium-tin-oxide (“ITO”), aluminum-tin-oxide, gold, silver, copper, and nickel. The anode may also comprise an organic material such as polyaniline.

The anode layer 110 may be formed by a chemical or physical vapor deposition process or spin-cast process. Chemical vapor deposition may be performed as a plasma-enhanced chemical vapor deposition (“PECVD”) or metal organic chemical vapor deposition (“MOCVD”). Physical vapor deposition can include all forms of sputtering, including ion beam sputtering, as well as e-beam evaporation and resistance evaporation. Specific forms of physical vapor deposition include rf magnetron sputtering and inductively-coupled plasma physical vapor deposition (“IMP-PVD”). These deposition techniques are well known within the semiconductor fabrication arts.

Usually, the anode layer 110 is patterned during a lithographic operation. The pattern may vary as desired. The layers can be formed in a pattern by, for example, positioning a patterned mask or resist on the first flexible composite barrier structure prior to applying the first electrical contact layer material. Alternatively, the layers can be applied as an overall layer (also called blanket deposit) and subsequently patterned using, for example, a patterned resist layer and wet chemical or dry etching techniques. Other processes for patterning that are well known in the art can also be used. When the electronic devices are located within an array, the anode layer 110 typically is formed into substantially parallel strips having lengths that extend in substantially the same direction.

The buffer layer 120 is usually cast onto substrates using a variety of techniques well-known to those skilled in the art. Typical casting techniques include, for example, solution casting, drop casting, curtain casting, spin-coating, screen printing, inkjet printing, and the like. Alternatively, the buffer layer can be patterned using a number of such processes, such as ink jet printing.

The electroluminescent (EL) layer 130 may typically be a conjugated polymer, such as poly(paraphenylenevinylene) or polyfluorene. The particular material chosen may depend on the specific application, potentials used during operation, or other factors. The EL layer 130 containing the electroluminescent organic material can be applied from solutions by any conventional technique, including spin-coating, casting, and printing. The EL organic materials can be applied directly by vapor deposition processes, depending upon the nature of the materials. In another embodiment, an EL polymer precursor can be applied and then converted to the polymer, typically by heat or other source of external energy (e.g., visible light or UV radiation).

Optional layer 140 can function both to facilitate electron injection/transport, and can also serve as a confinement layer to prevent quenching reactions at layer interfaces. More specifically, layer 140 may promote electron mobility and reduce the likelihood of a quenching reaction if layers 130 and 150 would otherwise be in direct contact. Examples of materials for optional layer 140 include metal-chelated oxinoid compounds (e.g., Alq₃ or the like); phenanthroline-based compounds (e.g., 2,9-dimethyl4,7-diphenyl-1,10-phenanthroline (“DDPA”), 4,7-diphenyl-1,10-phenanthroline (“DPA”), or the like); azole compounds (e.g., 2-(4-biphenylyl)-5-(4-t-butylphenyl)-1,3,4-oxadiazole (“PBD” or the like), 3-(4-biphenylyl)4-phenyl-5-(4-t-butylphenyl)-1,2,4-triazole (“TAZ” or the like); other similar compounds; or any one or more combinations thereof. Alternatively, optional layer 140 may be inorganic and comprise BaO, LiF, Li₂O, or the like.

The cathode layer 150 is an electrode that is particularly efficient for injecting electrons or negative charge carriers. The cathode layer 150 can be any metal or nonmetal having a lower work function than the first electrical contact layer (in this case, the anode layer 110). As used herein, the term “lower work function” is intended to mean a material having a work function no greater than about 4.4 eV. As used herein, “higher work function” is intended to mean a material having a work function of at least approximately 4.4 eV.

Materials for the cathode layer can be selected from alkali metals of Group 1 (e.g., Li, Na, K, Rb, Cs,), the Group 2 metals (e.g., Mg, Ca, Ba, or the like), the Group 12 metals, the lanthanides (e.g., Ce, Sm, Eu, or the like), and the actinides (e.g., Th, U, or the like). Materials such as aluminum, indium, yttrium, and combinations thereof, may also be used. Specific non-limiting examples of materials for the cathode layer 150 include barium, lithium, cerium, cesium, europium, rubidium, yttrium, magnesium, and samarium.

The cathode layer 150 is usually formed by a chemical or physical vapor deposition process. In general, the cathode layer will be patterned, as discussed above in reference to the anode layer 110. If the device lies within an array, the cathode layer 150 may be patterned into substantially parallel strips, where the lengths of the cathode layer strips extend in substantially the same direction and substantially perpendicular to the lengths of the anode layer strips. Electronic elements called pixels are formed at the cross points (where an anode layer strip intersects a cathode layer strip when the array is seen from a plan or top view).

In other embodiments, additional layer(s) may be present within organic electronic devices. For example, a layer (not shown) between the buffer layer 120 and the EL layer 130 may facilitate positive charge transport, band-gap matching of the layers, function as a protective layer, or the like. Similarly, additional layers (not shown) between the EL layer 130 and the cathode layer 150 may facilitate negative charge transport, band-gap matching between the layers, function as a protective layer, or the like. Layers that are known in the art can be used. In addition, any of the above-described layers can be made of two or more layers. Alternatively, some or all of inorganic anode layer 110, the buffer layer 120, the EL layer 130, and cathode layer 150, may be surface treated to increase charge carrier transport efficiency. The choice of materials for each of the component layers may be determined by balancing the goals of providing a device with high device efficiency with the cost of manufacturing, manufacturing complexities, or potentially other factors.

The different layers may have any suitable thickness. Inorganic anode layer 110 is usually no greater than approximately 500 nm, for example, approximately 10-200 nm; buffer layer 120, is usually no greater than approximately 250 nm, for example, approximately 50-200 nm; EL layer 130, is usually no greater than approximately 1000 nm, for example, approximately 50-80 nm; optional layer 140 is usually no greater than approximately 100 nm, for example, approximately 20-80 nm; and cathode layer 150 is usually no greater than approximately 100 nm, for example, approximately 1-50 nm. If the anode layer 110 or the cathode layer 150 needs to transmit at least some light, the thickness of such layer may not exceed approximately 100 nm.

Depending upon the application of the electronic device, the EL layer 130 can be a light-emitting layer that is activated by signal (such as in a light-emitting diode) or a layer of material that responds to radiant energy and generates a signal with or without an applied potential (such as detectors or voltaic cells). Examples of electronic devices that may respond to radiant energy are selected from photoconductive cells, photoresistors, photoswitches, phototransistors, and phototubes, and photovoltaic cells. After reading this specification, skilled artisans will be capable of selecting material(s) that are suitable for their particular applications. The light-emitting materials may be dispersed in a matrix of another material, with or without additives, but preferably form a layer alone. The EL layer 130 generally has a thickness in the range of approximately 50-500 nm.

In organic light emitting diodes (OLEDs), electrons and holes, injected from the cathode 150 and anode 110 layers, respectively, into the EL layer 130, form negative and positively charged polarons in the polymer. These polarons migrate under the influence of the applied electric field, forming a polaron exciton with an oppositely charged species and subsequently undergoing radiative recombination. A sufficient potential difference between the anode and cathode, usually less than approximately 12 volts, and in many instances no greater than approximately 5 volts, may be applied to the device. The actual potential difference may depend on the use of the device in a larger electronic component. In many embodiments, the anode layer 110 is biased to a positive voltage and the cathode layer 150 is at substantially ground potential or zero volts during the operation of the electronic device. A battery or other power source(s) may be electrically connected to the electronic device as part of a circuit but is not illustrated in FIG. 1.

In yet another embodiment of the invention, there are provided methods for stabilizing the room temperature viscosity of an aqueous dispersion of an electrically conducting polymer, comprising contacting the dispersion with at least one ion exchange resin under conditions suitable to stabilize the room temperature viscosity of the aqueous dispersion.

The invention will now be described in greater detail by reference to the following non-limiting examples.

### EXAMPLES

Measurement methods:

Viscosity:

Viscosity of the samples was obtained with an AR1000-N rheometer from TA Instruments. The gap where liquid samples were placed between two parallel plates was set at 50 micrometers. Each experiment was conducted twice, and the results of both tests are reported.

Light emission measurement:

Current vs. voltage, light emission intensity vs. voltage, and efficiency were measured with a Keithley 236 source-measure unit (Keithley Instrument Inc., Cleveland, Ohio), and a S370 optometer with a calibrated silicon photodiode (UDT Sensor, Inc., Hawthorne, Calif.).

Stress half-life:

A fixed current of about 3 mA/cm² was applied to a device continuously at an elevated temperature, typically 80° C. The stress half-life was the time, in hours, required for the brightness to be reduced to one-half the initial value.

### Comparative Example 1

This example illustrates viscosity instability of a 1.0 w. % PAni/PMMPSA aqueous dispersion made from a polymer powder isolated by acetone precipitation.

60.70 g (43.93 mmoles of acid monomer units) PAAMPSA (Aldrich, Cat # 19,197-3, lot # 07623EO, M_{w}˜2 million, 15% solid in water) was introduced into a jacketed one liter three-necked flask., followed by 334.84 g deionized water. The flask was equipped with a stirring paddle powered by an air-driven overhead stirrer and a small tube for adding ammonium persulfate. The small tube was placed inside a glass pipette with the tip removed and the pipette was inserted through a 29 size septa so that the end of the tube extended out of the pipette approximately ½″ above the reaction mixture. A thermocouple with an inlet for monitoring the temperature of the polymerization liquid in the jacketed flask was used to keep circulation of the fluid at 22° C. After stirring of the PAAMPSA/water mixture commenced, freshly distilled aniline (4.0 mL, 43.9 mmoles) was added to the flask via a transfer pipette. The mixture was allowed react with stirring for approximately one hour. While stirring continued, ammonium persulfate (4.01 g, 17.572 mmoles, 99.999+% pure from Aldrich) was massed into a scintillation vial, and the mass was mixed with 16.38 g deionized water. This mixture was placed in a Norm-Ject 30 ml syringe, which was connected to the tube in the flask using a 17-gauge syringe needle. The syringe was connected to a Harvard Apparatus 44 Syringe Pump programmed to add the ammonium persulfate (APS) over 30 minutes. During the addition of APS, temperature of the mixture was about 23° C. The reaction mixture turned blue one minute after addition of APS began and started to darken. After addition of the APS solution was completed, the reaction was allowed to proceed for 24 hours with constant stirring.

After 24 hours, the reaction mixture was poured into a 4L plastic Nalgene® beaker, agitation from the overhead stirrer was started, and acetone (2000 L) was poured into the 4L beaker. Stirring of the acetone mixture continued for 37 minutes. Once stirring was stopped, the mixture was allowed to settle into two layers. Most of the reddish-yellow liquid phase was decanted, leaving behind a tarry solid product, which was then filtered with a Buchner funnel equipped with Whatman #54 filter paper. The collected solid was placed in a 1 L Erlenmeyer flask and the flask was positioned for stirring using an overhead air-driven motor. 500 ml acetone was then placed into the flask for further acetone cleaning of the product. The acetone mixture was allowed to stir for approximately 40 minutes and then was left standing to allow the solid product to settle to the bottom of the flask. Once the liquid was decanted, 500 ml fresh acetone was added to the flask and the mixture was stirred for approximately 30 additional minutes. The slurry was suction-filtered through a Buchner funnel equipped with Whatman #54 filter paper while a greenish solid product collected on the filter paper. The filtrate was clear and colorless. The funnel and its contents were placed into a vacuum oven and dried overnight (˜20 inch mercury, nitrogen bleed, ambient temperature). Yield was 6.2 g.

From the PAni/PAAMPSA polymer synthesized above a 1 wt % aqueous dispersion was prepared for viscosity measurement by mixing 0.1038 g of the PAni/PAAMPSA with 9.9154 g deionized water. Once made, viscosity of the dispersion was determined immediately at room temperature at shear rates of 10, 100, 1000, and 9000 S⁻¹, which viscosity measurements are shown as the viscosities at day zero in Table I. Table I also shows the viscosity of the aqueous dispersion after storing at room temperature for 7 days and 14 days. The data summarized in Table I clearly show that viscosity of the dispersion declined over time, indicating that the dispersion is unstable. The viscosity dropped to one seventh of the original viscosity in 14 days.

TABLE I
Viscosity of PAni/PAAMPSA aqueous dispersion prepared with
acetone precipitation

| | Viscosity (cps) | | | |
|---|---|---|---|---|
| | shear rate | | | |
| Aging time (days) | 10 s⁻¹ | 100 s⁻¹ | 1,000 s⁻¹ | 9,000 s⁻¹ |
| 0 | (230; 186) | (82; 77) | (35; 32) | (14; 15) |
| 7 | (77; 70) | (39; 38) | (21; 19) | (10.6; 9.9) |
| 14 | (35; 34) | (19; 20) | (11; 12) | (6.7; 7.1) |

### Invention Example 1

This example illustrates that a 1.0 wt % PAni/PAAMPSA aqueous dispersion, wherein acetone precipitation is replaced by treatment with ion exchange resins, has enhanced viscosity stability and light emitting properties when used in an EL device.

60.64 g (43.89 mmoles of acid monomer units) PAAMPSA (Aldrich Cat # 19,197-3, lot # 07623EO, M_{w}˜2 million, 15% solid in water) was introduced to a jacketed one liter three-necked flask as described in Comparative Example 1, followed by 335.21 g deionized water. Stirring of the PMMPSA/water mixture began and polymerization was carried out in the same manner as in Comparative Example 1. Distilled aniline (4.0 ml, 43.9 mmoles) was added to the flask via a transfer pipette and the mixture was allowed to stir for a period of approximately one hour. While being stirred, 5.01 g (21.954 mmoles) ammonium persulfate (99.999+% pure from Aldrich) was massed into a scintillation vial, the mass was mixed with 15.24 g deionized water, and the mixture was placed in a Norm-Ject 30 ml syringe, which was connected to the tube in the flask using a 17-gauge syringe needle. The syringe was connected to a Harvard Apparatus 44 Syringe Pump, which was programmed to add the ammonium persulfate (APS) over 60 minutes. During the addition of APS, the temperature of the mixture was about 23° C. Within two minutes of APS addiiton, the reaction mixture turned blue and started to darken. After addition of the APS solution, the reaction was allowed to proceed for 24 hours under constant stirring.

At the end of the 24 hours, 630.27 g deionized water was added to the reaction mixture for a 40.0% dilution, which amounts to 1.25 wt % PAni/PMMPSA, assuming no loss of PMMPSA and total conversion of aniline. The diluted mixture was treated with two ionic exchange resins. One of the two resins used is Lewatit® S100, a trade name from Bayer, Pittsburgh, Pa., USA for sodium sulfonate of crosslinked polystyrene. The other ionic exchange resin is Lewatite® MP62 WS, a trade name of Bayer, Pittsburgh, Pa., USA for free base/chloride of tertiary amine of crosslinked polystyrene. The two resins were washed separately before use with deionized water until the water was colorless. 38.71 g of Lewatit® S100 and 38.96 g of Lewatit® MP62® WS were added to the reaction flask and the slurry was stirred for 20 hours. The resulting slurry was then suction-filtered through a Buchner Funnel equipped with Whatman #54 Filter paper. Yield 954 g. The filtered dispersion was measured with a pH meter model 63 made by Jenco Electronics, Inc. and was found to be 6.0. In spite of the high pH, the dispersion is still green in color, indicative of electrically conductive emeraldine salt form.

For viscosity measurements, 5.9737 g of the resin-treated PAni/PMMPSA dispersion was added to 2.3704 g deionized water to dilute the dispersion from a 1.25%(w/w) to a 0.9%(w/w) PAni/PMMPSA aqueous dispersion. Viscosity of the PAni/PMMPSA dispersion was determined immediately at room temperature at shear rates of 10,100, 1,000, and 9,000 s⁻¹, which viscosity measurements are shown as the viscosities at day zero in Table II. Table II also shows the viscosity after the dispersion was left undisturbed at room temperature for 7, 14 and 21 days. These data clearly show that the dispersion prepared using ionic exchange resins is stable for at least 21 days.

TABLE II
Viscosity of PAni/PAAMPSA aqueous dispersion made without
isolation by acetone precipitation

| | Viscosity (cps) | | | |
|---|---|---|---|---|
| | shear rate | | | |
| Aging time (days) | 10 s⁻¹ | 100 s⁻¹ | 1,000 s⁻¹ | 9,000 s⁻¹ |
| 0 | (17.6; 13.7) | (13.7; 10.0) | (10.2; 7.8) | (6.3; 4.9) |
| 7 | (28; 38) | (12.3; 13.1) | (7.8; 8.2) | (4.9; 5.1) |
| 14 | (16.0; 12.5) | (11.7; 12.1) | (9.2; 9.6) | (6.0; 6.3) |
| 21 | (13.7; 14.0) | (11.4; 10.0) | (9.1; 8.3) | (5.9; 5.6) |

The resin-treated aqueous PAni/PAAMPSA (1.25% w/w) dispersion described above without further dilution with water was tested for electrical conductivity and light emission properties as follows. Glass/ITO substrates (30 mm×30 mm) having ITO thickness of 100 to 150 nm (nanometer) were cleaned and subsequently treated with oxygen plasma. The ITO substrates used for electrical conductivity tests were prepared with parallel etched-lines of ITO for measurement of electrical resistance. The ITO substrates for light emission measurements were prepared with 15 mm×20 mm area of ITO for light emission.

The aqueous PAni/PMMPSA dispersion was spin-coated onto the ITO/glass substrates at a spinning speed of 1000 rpm to yield a thickness of 126 nm. The PAni/PMMPSA coated ITO/glass substrates were dried in nitrogen at 90° C. for 30 minutes. Electrical conductivity of the PAni/PAAMPSA film was determined to be 1.1×10⁻³ S/cm.

For light emission measurements, the PAni/PMMAPSA layer was then top-coated with a super-yellow emitter (PDY 131), which is a poly(substituted-phenylene vinylene) (Covion Company, Frankfurt, Germany). The thickness of the electroluminescent (EL) layer was approximately 70 nm. Thickness of all films was measured with a TENCOR 500 Surface Profiler. For the cathode, Ba and Al layers were vapor-deposited on top of the EL layers under a vacuum of 1×10⁻⁶ torr. The final thickness of the Ba layer was 30 Å; the thickness of the Al layer was 3000 Å. Device performance was tested as follows. Current vs. voltage, light emission intensity vs. voltage, and efficiency were measured with a 236 source-measure unit (Keithley) and a S370 Optometer with a calibrated silicon photodiode (UDT Sensor). Five tested light emitting devices showed operating voltage ranging from 3.8 volts to 4.0 volts and light emission efficiency ranging from 6.5 Cd/A to 8.8 Cd/A (Cd: candela; A: amperage) light emission efficiency at 200 Cd/m². Average stress half-life at 80° C. was 83 hrs.

### Comparative Example 2

This Example describes an aqueous PAni/PAAMPSA dispersion prepared without isolating the PAni/PMMPSA and without ion exchange resin treatment and properties of a light emitting device prepared therefrom.

45.45 g (32.90 mmoles of acid monomer units) PAAMPSA (Aldrich (Cat # 19,197-3, lot # 07623EO, M_{w}˜2 million, 15% solid in water) was added to a total of 296.66 g nano-pure water in a 500 ml Nalgen® Plastic bottle The PAAMPSA/water mixture was then placed onto a roller for mixing for two hours before transfer into a jacketed one liter three-necked flask. Stirring of the PAAMPSA/water mixture commenced and polymerization was carried out in the same manner as in Invention Example 1. Distilled aniline (3.0 ml, 8.23 mmoles) was added via a transfer pipette. The mixture was allowed to stir for a period of approximately one hour. While being stirred, 3.03 g (13.278 mmoles) ammonium persulfate (99.999+% pure from Aldrich) was massed into a scintillation vial, the mass was mixed with 12.17 g deionized water, and the mixture was placed into a Norm-Ject 30 ml syringe, which was connected to the tube in the flask using a 17-gauge syringe needle. The syringe was connected to a Harvard Apparatus 44 Syringe Pump that was programmed to add ammonium persulfate (APS) in 30 minutes. During the addition of APS, temperature was about 23° C. The reaction mixture turned blue in two minutes and started to darken. After addition of the APS solution, the reaction mixture was allowed to proceed for 24 hours with constant stirring.

At the end of the 24 hours, 472.389 g deionized water was added to the reaction mixture for about 40.0% dilution, which amounts to 1.25 wt % PAni/PAAMPSA assuming no loss of PAAMPSA and total conversion of aniline. The diluted mixture, which was stirred for approximately 30 minutes, weighed 742.87 g. The diluted mixture was measured with a pH meter model 63 made by Jenco Electronics, Inc. and was found to be 1.7, which is very acidic. The diluted mixture was divided into three portions. Two of the three portions were used for resin treatment as describer in Invention Example 2A and Invention Example 2B. The remaining portion was used soon after in this Comparative Example 2 for testing of electrical conductivity and device properties. Sample devices were prepared and tested as described in Example 1. Results of the testing are summarized in Table III. Electrical conductivity of the PAni/PAAMPSA film was determined to be 1.1×10⁻² S/cm. Average stress life at 80° C. was only 1.6 hrs.

Invention Example 2A

This Example describes a 1.0 wt % PAni/PAAMPSA aqueous dispersion prepared as in Comparative Example 2, and treated with Lewatit® resins and properties of a device prepared therefrom

One portion of the 1.25% (w/w) PAni/PMMPSA aqueous dispersion described in Comparative Example 2, which weighed 256.97 g, was mixed with 8.23 g Lewatit® S100 and 8.05 g Lewatit® MP62 WS in a 500 ml Nalgene® Plastic bottle. The resulting slurry in the bottle was placed onto a twin roller for about 8 hours. Both resins were described in Invention Example 1 and were washed before use with deionized water separately until the water was colorless. The resin-treated slurry was then suction-filtered through a Buchner Funnel equipped with Whatman #54 Filter paper. Yield 213.67 g.

The resin-treated aqueous dispersion was used soon after for testing of electrical conductivity and device properties. Preparation of sample devices and testing were performed as described in Invention Example 1 and the results of the tests are summarized in Table 111. Electrical conductivity of the PAni/PMMPSA film was determined to be 3.9×10⁻⁴ S/cm. Average stress life is 42 hrs. This example demonstrates effectiveness of resin-treatment in reducing conductivity and improving stress life when compared with Comparative Example 2 where the aqueous dispersion used for preparation of sample devices was not treated with ion exchange resins.

Invention Example 2B

This example describes a 1.0 wt % PAni/PMMPSA aqueous dispersion prepared as in Comparative Example 2, but treated with Dowex resins and properties of a device prepared therefrom

A second portion (262.55 g) of the 1.25 wt % PAni/PMMPSA aqueous dispersion described in Comparative Example 2, was mixed with 30.6 Dowex® 550A anion-exchange resin and 30.66 g Dowex®) 66 exchange resin in a 500 ml Nalgene® Plastic bottle. Dowex® 550A is a quaternary amine anion exchange resin and Dowex®66 is a tertiary amine ion exchange resin (Dow Chemical Company, MI) The resins were washed repeatedly with deionized water until there was no color or odor in the water washings prior to use. The resulting slurry in the bottle was placed onto a twin roller for about 8 hours. The resin-treated slurry was then suction-filtered through a Buchner Funnel equipped with Whatman #54 Filter paper. Yield 220.76 g. The filtered dispersion was measured with a pH meter model 63 made by Jenco Electronics, Inc. and was found to be 5.0, In spite of the high pH, the dispersion is still green in color, indicative of electrically conductive emeraldine salt form.

The resin treated aqueous dispersion was used soon after for testing of electrical conductivity and device properties. Preparation of samples devices and testing were as described in Invention Example 1 and results of the above-described tests are summarized in Table III. Electrical conductivity of the PAni/PAAMPSA film was determined to be 9.7×10⁻⁵ S/cm. Average stress life was 128 hrs.

This example demonstrates effectiveness of resin-treatment in reducing conductivity and improving stress life when compared with Comparative Example 2 where the aqueous dispersion used for preparation of sample devices was not treated with ion exchange resins.

TABLE III
Properties of devices containing buffer layers cast from PAni/PAAMPSA aqueous
dispersions prepared with and without ion exchange resin treatment

| | | | Voltage (volt) | Efficiency (Cd/A) | Initial | |
|---|---|---|---|---|---|---|
| | Coating | | @ 200 Cd/m2 | @ 200 Cd/m2 | Brightness | Half-life |
| | thickness | Conductivity | at room | at room | at 80° C. | (hr) |
| Example | (nm) | (S/cm) | temperature | temperature | (Cd/m²) | at 80° C. |
| Comparative | 153 @ | 1.1 × 10⁻² | 3.8-4.0 | 4.7-8.5 | 176 | 1.6 |
| Example 2 | 1,000 rpm | | | | | |
| Invention | 124 @ | 3.9 × 10⁻⁴ | 3.9-4.0 | 6.6-9.1 | 162 | 42 |
| Example 2A | 1,000 rpm | | | | | |
| Invention | 79 @ | 9.7 × 10⁻⁵ | 3.5-3.8 | 6.4-8.6 | 177 | 128 |
| Example 2B | 1,200 rpm | | | | | |

While the invention has been described in detail with reference to certain preferred embodiments thereof, it will be understood that modifications and variations are within the spirit and scope of that which is described and claimed.

What is claimed is:

1. A method for directly producing a stable aqueous dispersion of an electrically conducting polyaniline, comprising
a) synthesizing an electrically conducting polyaniline in the presence of a polymeric acid in aqueous solution, thereby forming an as-synthesized aqueous dispersion comprising the electrically conducting polyaniline and the polymeric acid, and
b) contacting said as-synthesized aqueous dispersion with at least one ion exchange resin under conditions suitable to produce a stable aqueous dispersion of an electrically conducting polyaniline.

2. The method of claim 1, comprising contacting said as-synthesized aqueous dispersion with a first ion exchange resin and a second ion exchange resin.

3. The method of claim 2, wherein said contacting of said as-synthesized aqueous dispersion with said first ion exchange resin and said second ion exchange resin is simultaneous.

4. The method of claim 2, wherein said contacting of said as-synthesized aqueous dispersion with said first ion exchange resin and said second ion exchange resin is consecutive.

5. The method of claim 2, wherein said first ion exchange resin is an acidic, cation exchange resin.

6. The method of claim 1, wherein the stable aqueous dispersion of electrically conducting polyaniline has a pH greater than 1.5.

7. The method of claim 1, wherein the pH is greater than 3.

8. The method of claim 5, wherein said acidic, cation exchange resin is a sulfonic acid cation exchange resin.

9. The method of claim 2, wherein said second ion exchange resin is a basic, anion exchange resin.

10. The method of claim 9, wherein said basic, anion exchange resin is selected from a tertiary amine anion exchange resin or a quaternary amine anion exchange resin.

11. The method of claim 1, wherein the stable aqueous dispersion remains at substantially constant viscosity for at least about one month.

12. The method of claim 1, wherein the conditions comprise contacting the as-synthesized aqueous dispersion with the ion exchange resin for at least about 1 hour at room temperature.

13. The method of claim 1, wherein the weight ratio of ion exchange resin to electrically conducting polyaniline/polymeric acid is about 1:1.

14. The method of claim 1, wherein said polymeric acid is selected from polymeric sulfonic acid, polymeric carboxylic acid, and polymeric phosphoric acid.

15. The method of claim 14, wherein said polymeric acid is a polymeric sulfonic acid.

16. The method of claim 15, wherein said polymeric sulfonic acid is selected from poly(2-acrylamido-2-methyl-1-propanesulfonic acid) (PAAMPSA), polystyrenesulfonic acid, poly(2-methylstyrene sulfonic acid), poly(4-phenylstyrene sulfonic acid), sulfonated poly(α-vinyl naphthalene), poly (vinyl sulfonic acid), sulfonated poly(vinyl benzoate), sulfonated poly(benzyl acrylate), and sulfonated poly(benzyl methacrylate).

17. The method of claim 16, wherein said polymeric sulfonic acid is poly(2-acrylamido-2-methyl-1-propanesulfonic acid) (PAAM PSA).

18. A method for directly producing a stable aqueous dispersion of electrically conducting polyaniline, comprising
a) polymerizing aniline monomers in the presence of poly(2-acrylamido-2-methyl-1-propanesulfonic acid) (PAAMPSA) in aqueous solution, thereby forming an as-synthesized aqueous dispersion comprising polyaniline and said PAAMPSA, and
b) contacting said as-synthesized aqueous dispersion with an acidic, cation exchange resin and a basic, anion exchange resin under conditions suitable to produce a stable aqueous dispersion of electrically conducting polyaniline.

19. The method of claim 18, wherein said acidic, cation exchange resin is a sulfonic acid cation exchange resin.

20. The method of claim 18, wherein said basic, anion exchange resin is a tertiary amine anion exchange resin.

21. A method for reducing conductivity of a polyaniline/polymeric acid buffer layer cast from aqueous solution onto a substrate to a value less than about 1×10⁻⁴ S/cm, comprising contacting the aqueous solution with an acidic, cation exchange resin and a basic, anion exchange resin under conditions suitable to reduce conductivity of a polyaniline/polymeric acid buffer layer cast therefrom.

22. A buffer layer produced according to the method of claim 21.

23. An electroluminescent device comprising the buffer layer according to claim 22.

24. A method for stabilizing the room temperature viscosity of an aqueous dispersion of an electrically conducting polyaniline, comprising contacting the dispersion with at least one ion exchange resin under conditions suitable to stabilize the room temperature viscosity of the aqueous dispersion.

25. A stable aqueous dispersion of an electrically conducting polyaniline having an initial viscosity and a viscosity measured after 336 hours, wherein the viscosity measured after 336 hours is at least 80% of the initial viscosity, and wherein all viscosities are measured at a shear rate of 10 s⁻¹.

26. The dispersion of claim 25 wherein the electrically conducting polyaniline comprises an acid/base salt of the emeraldine base of polyaniline and poly(2-acrylamido-2-methyl-1-propanesulfonic acid.

27. The dispersion of claim 25 wherein the viscosity measured after 336 hours is at least 90% of the initial viscosity.

28. The dispersion of claim 25 wherein the viscosity measured after 504 hours is at least 75% of the initial viscosity.

29. The dispersion of claim 25 wherein the electrically conducting polyaniline dispersion has a viscosity measured after 504 hours, and further wherein the viscosity measured after 504 hours is at least 75% of the initial viscosity.

30. A stable aqueous dispersion of an electrically conducting polyaniline produced according to the method of claim 1.

31. A stable aqueous dispersion of an electrically conducting polyaniline produced according to the method of claim 18.

32. A method for increasing the pH of an aqueous dispersion of polyaniline/polymeric acid to a value greater than 1.5, comprising contacting the aqueous dispersion with an acidic, cation exchange resin and a basic, anion exchange resin under conditions suitable to increase the pH.

33. An electroluminescent device comprising the buffer layer made in accordance with the method of claim 32 and deposited on the anode of said device.

34. The method of claim 1, wherein the stable aqueous dispersion of electrically conducting polyaniline has a pH greater than 1.5.

35. The method of claim 34, wherein the pH is greater than 3.
